(19) United States
(12) Patent Application Publication
(10) Pub. No.: US 2026/0102227 A1
(43) Pub. Date: Apr. 16, 2026

(54) ORTHODONTIC ATTACHMENT WITH CANTILEVERED HOOK

(71) Applicant: Zhi Chun Song, Anmore (CA)

(72) Inventor: Zhi Chun Song, Anmore (CA)

(21) Appl. No.: 19/202,387

(22) Filed: May 8, 2025

Related U.S. Application Data
(63) Continuation-in-part of application No. 18/912,197, filed on Oct. 10, 2024.

(30) Foreign Application Priority Data
Nov. 26, 2024 (CA) CA/2024/051571

(51) Int. Cl. A61C 7/36

(52) U.S. Cl. CPC A61C 7/36

(57) ABSTRACT

An orthodontic hook includes a base pad attachable to one of a tooth surface and an orthodontic appliance, and includes a hook body having a connection part projecting from the base pad and a cantilevered part extending laterally from the connection part. The cantilevered part includes first and second members separated from each other by a slot, and includes a joint member next to the connection part for connecting between the first member and the second member. A first end of the first member forms a first protrusion protruding toward the second member, a second end of the second member forms a second protrusion protruding toward the first member, the first member defines a first extremity which is maximally proximate to the second member, the second member defines a second extremity which is maximally proximate to the first member, a slot constriction is defined between the first extremity and the second extremity. The slot constriction is positioned at a terminal edge of the cantilevered part.

### CROSS-REFERENCE TO RELATED APPLICATIONS

This application is a continuation-in-part of U.S. application Ser. No. 18/912,197, filed Oct. 10, 2024, the entire contents of which are hereby incorporated by reference.

This application claims priority of Patent Cooperation Treaty (PCT) international application No. CA/2024/051571, filed in Canada on 2024 Nov. 26, the entire contents of which are hereby incorporated by reference.

### BACKGROUND OF THE INVENTION

### 1. Field of Invention

This invention relates to dentistry and, in particular, to an orthodontic attachment or appliance forming a hook.

### 2. Description of Related Art

While braces and aligners straighten teeth, they do not align the bite. Dental elastics may be used in conjunction with either braces or aligners to treat malocclusion, or a misaligned bite. Other orthodontic appliances like the known Carriere® Motion appliance may also use elastic rubber bands to correct the relationship between the upper and lower jaws.

Currently, there are many attachment options available for elastic rubber bands. Such conventional attachment options are referred to as elastic hooks. It can be difficult to install an elastic hook when a patient has short crowns. In some cases, the aligner cannot control the tooth position after a cutout has been made for the elastic hook. In other cases, the elastic hook is not close to the resistance center of the tooth such that the tooth does not readily move bodily. For these reasons, an improved elastic hook is proposed herein to solve these problems.

### SUMMARY

The above shortcomings may be addressed by providing an orthodontic hook attachable to one of a tooth surface and an orthodontic appliance. The hook comprises: (a) a base pad attachable to one of the tooth surface and the orthodontic appliance; and (b) a hook body comprising a connection part projecting from the base pad, and a cantilevered part extending laterally from the connection part, the cantilevered part including a first member and a second member separated from the first member by a slot formed in the cantilevered part, the cantilevered part further including a joint member disposed next to the connection part. The joint member is connected between the first member and the second member. The joint member is disposed at an end of the slot. The first member defines a first extremity which is maximally proximate to the second member and defines a third extremity which is maximally distal from the joint member. The second member defines a second extremity which is maximally proximate to the first member and defines a fourth extremity which is maximally distal from the joint member. A slot opening is formed between the third extremity and the fourth extremity, and a slot constriction is formed between the first extremity and the second extremity. The slot continuously narrows from the slot opening to the slot constriction. A first distance between the third extremity and the fourth extremity is larger by at least 3 times than a second distance between the first extremity and the second extremity.

A first end of the first member may form a first protrusion protruding toward the second member, and the first protrusion may have a tapered shape and taper from the third extremity to the first extremity. A second end of the second member may form a second protrusion protruding toward the first member, and the second protrusion may have a tapered shape and taper from the fourth extremity to the second extremity. A third distance between the third extremity and the first extremity may be larger than the second distance. A fourth distance between the fourth extremity and the second extremity may be larger than the second distance. A third distance between the third extremity and the first extremity may be larger by at least 1.2 times than the second distance. A fourth distance between the fourth extremity and the second extremity may be larger by at least 1.2 times than the second distance. The slot opening may be positioned at a terminal edge of the cantilevered part. The second distance may be less than 0.8 mm. The second distance may be less than 0.6 mm. The first distance may be larger by at least 2.6 times than the second distance. A third distance between the third extremity and the first extremity may be larger by at least 3 times than the second distance. A fourth distance between the fourth extremity and the second extremity may be larger by at least 3 times than the second distance. A third distance between the third extremity and the first extremity may be larger by at least 2 times than the second distance. A fourth distance between the fourth extremity and the second extremity may be larger by at least 2 times than the second distance. The first distance may be larger by at least 4 times than the second distance. The slot may continuously narrow from the slot opening to the slot constriction. The slot may continuously widen from the slot constriction to the slot center. The second distance may be less than 0.5 mm. A first indentation of the first member may be formed between the joint member and the first end of the first member, and a second indentation of the second member may be formed between the joint member and the second end of the second member. The first indentation may be placed at a first side edge of the cantilevered part at the first member, and the second indentation may be placed at a second side edge of the cantilevered part at the second member. The first indentation may be arranged at a top surface and a bottom surface of the cantilevered part at the first member, and the second indentation may be arranged at a top surface and a bottom surface of the cantilevered part at the second member.

Another character of the orthodontic hook is that the orthodontic hook is attachable to one of a tooth surface and an orthodontic appliance, the hook comprises (a) a base pad attachable to said one of the tooth surface and the orthodontic appliance; and (b) a hook body comprising a connection part projecting from the base pad, and a cantilevered part extending laterally from the connection part, the cantilevered part comprises a first member and a second member separated from the first member by a slot formed in the cantilevered part, the cantilevered part further comprises a joint member disposed next to the connection part, the joint member is disposed at an end of the slot for connecting between the first member and the second member, a first end of the first member forms a first protrusion protruding toward the second member, a second end of the second member forms a second protrusion protruding toward the first member, the first member defines a first extremity which is maximally proximate to the second member, the second member defines a second extremity which is maximally proximate to the first member, a slot constriction is defined between the first extremity and the second extremity, the slot constriction is positioned at a terminal edge of the cantilevered part.

The first member may define a third extremity which is maximally distal from the joint member, the second member may define a fourth extremity which is maximally distal from the joint member, the slot opening may be defined between the third extremity and the fourth extremity, a slot constriction may be defined between the first extremity and the second extremity, and the slot may continuously narrow from the slot opening to the slot constriction. A first distance between the third extremity and the fourth extremity may be larger by at least 3 times than a second distance between the first extremity and the second extremity. A third distance between the third extremity and the first extremity may be larger by at least 2 times than a second distance between the first extremity and the second extremity. A fourth distance between the fourth extremity and the second extremity may be larger by at least 2 times than the second distance. A first indentation of the cantilevered part may be formed at the first member between the joint member and the first end of the first member, and a second indentation of the cantilevered part may be formed at the second member between the joint member and the second end of the second member. The first indentation may be placed at a first side edge of the cantilevered part at the first member, and the second indentation may be placed at a second side edge of the cantilevered part at the second member. The first indentation may be arranged at a top surface and a bottom surface of the cantilevered part at the first member, and the second indentation may be arranged at a top surface and a bottom surface of the cantilevered part at the second member. The first protrusion may have a tapered shape and taper from the third extremity to the first extremity. The second protrusion may have a tapered shape and taper from the fourth extremity to the second extremity.

The foregoing summary is illustrative only and is not intended to be in any way limiting. Other aspects and features of the present invention will become apparent to those of ordinary skill in the art upon review of the following description of embodiments of the invention in conjunction with the accompanying figures and claims.

### BRIEF DESCRIPTION OF THE DRAWINGS

Various objects, features and advantages of the invention will be apparent from the following description of embodiments of the invention, as illustrated in the accompanying drawings. The drawings are not necessarily to scale, emphasis instead being placed upon illustrating the principles of various embodiments of the invention.

FIG. 1 is a perspective view of a first embodiment of an orthodontic hook.

FIG. 2 is a top view of the first embodiment of the orthodontic hook.

FIG. 3 is a side view of the first embodiment of the orthodontic hook.

FIG. 4 is a perspective view of a second embodiment of an orthodontic hook.

FIG. 5 is a top view of the second embodiment of the orthodontic hook.

FIG. 6 is a side view of the second embodiment of the orthodontic hook.

FIG. 7 is a perspective view of a third embodiment of an orthodontic hook.

FIG. 8 is a top view of the third embodiment of the orthodontic hook.

FIG. 9 is a side view of the third embodiment of the orthodontic hook.

FIG. 10 is a perspective view of a fourth embodiment of an orthodontic hook.

FIG. 11 is a top view of the fourth embodiment of the orthodontic hook.

FIG. 12 is a side view of the fourth embodiment of the orthodontic hook.

### DETAILED DESCRIPTION

An apparatus for retaining an elastic band includes: (a) means for receiving the elastic band into a slot; (b) means for guiding the elastic band from a slot opening to a slot constriction so as to enter a slot center, the width of the slot opening being at least 3 times the width of the slot constriction; (c) means for engaging with an aligner to align the teeth; and (d) means for arranging the slot to be in a cantilevered part of the apparatus.

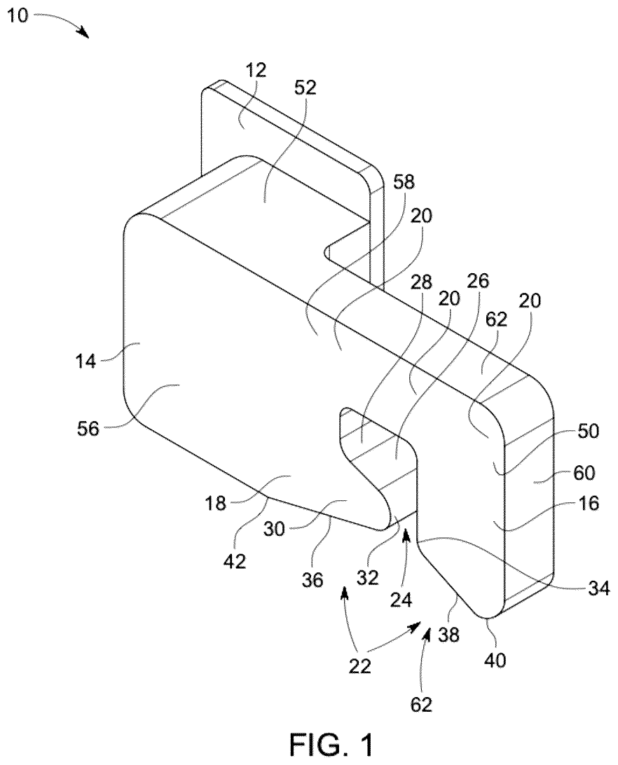

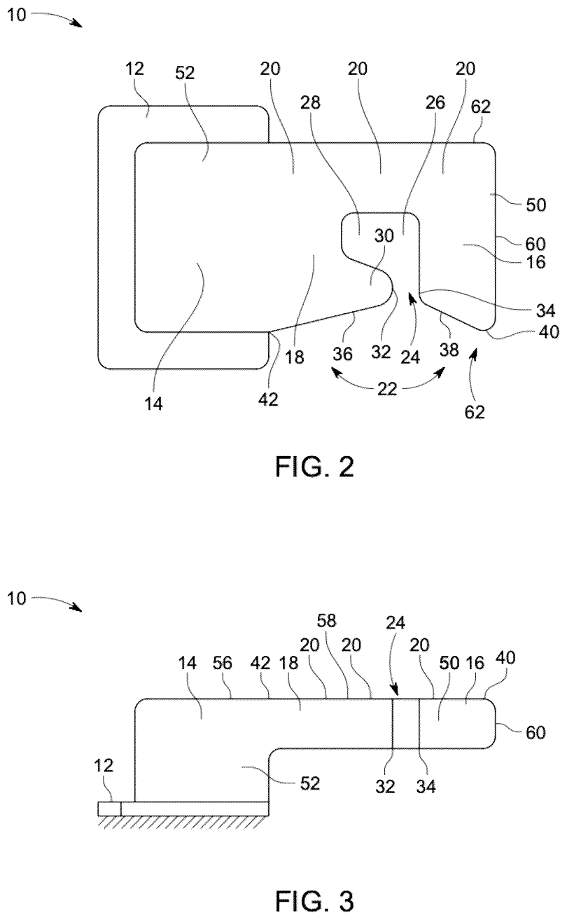

FIG. 1 is a perspective view of the first embodiment of an orthodontic hook, and FIG. 2 is a top view of the first embodiment of the orthodontic hook 10. The orthodontic hook 10 is attachable to one of a tooth surface (not shown) and an orthodontic appliance (not shown). The hook 10 includes a base pad 12 that is attachable to the tooth surface. In some circumstances, the base pad 12 is instead attached to an orthodontic appliance. The base pad 12 may have different shapes, like a circle, a rectangle, an oval, or an irregular shape. In the first embodiment, the outer surface of this base pad 12 for cementing with the tooth surface is a flat surface. In some embodiments, the base pad 12 has a curved surface conforming to the tooth surface.

The orthodontic hook 10 includes a hook body 52 that includes a connection part 14 projecting from the base pad 12. A cantilevered part 50 of the hook body 52 extends laterally from the connection part 14. The connection part 14 can be the orthodontic appliance such as a Carriere® Motion Appliance, Buccal Tube, Attachment, or Bracket etc. The cantilevered part 50 comprises a first member 18, a second member 16, and a joint member 20. A slot 28 is formed in the cantilevered part 50, and the first member 18 and the second member 16 are separated from each other by the slot 28. The joint member 20 next to the connection part 14 connects the first member 18 to the second member 16, and the joint member 20 is placed between the first member 18 and the second member 16. The joint member 20 is disposed at the end of the slot 28. The end of the first member 18 forms a first protrusion 30 protruding toward the second member 16. The first protrusion 30 has a tapered shape and tapers to a first extremity 32, of the first member 18, which is maximally proximate to the second member 16. The first extremity 32 is also the end 32 of the first protrusion 30 in this embodiment. A second extremity 34 of the second member 16 is maximally proximate to the first member 18, a slot constriction 24 is formed in and defined by the cantilevered part 50 between the first extremity 32 and the second member, and the slot constriction 24 extends between the first extremity 32 and the second extremity 34. The slot 28 has a slot opening 22 at one of the side edges 62 of the cantilevered part 50 in this embodiment. However, in other embodiments the slot opening 22 may be located at the other side edge 62 or at the terminal edge 60 of the cantilevered part 50. The first member 18 defines a third extremity 42 which is maximally distal from the joint member 20, and the second member 16 defines a fourth extremity 40 which is maximally distal from the joint member 20. The slot opening 22 extends between the third extremity 42 and the fourth extremity 40. The slot center 26 is surrounded by the first member 18, the second member 16, the joint member 20, and the first protrusion 30. The slot 28 narrows from the slot opening 22 to the slot constriction 24 and widens from the slot constriction 24 to the slot center 26. A first guiding surface 36 is formed between the third extremity 42 and the first extremity 32, and a second guiding surface 38 is formed between the fourth extremity 40 and the second extremity 34. The narrow slot constriction 24 and the big slot opening 22 makes the guiding surfaces 36 and 38 advantageously long. After the slot opening 22 catches the elastic rubber band (not shown), the elastic rubber band can be readily guided into the narrow slot constriction 24. These big guiding surfaces 36 and 38 make the narrow slot constriction 24 advantageously functional in the clinic, and at the same time the hook 10 is minimally irritating and advantageously inhibits the elastic rubber band from unintentionally escaping when the elastic rubber band is pulled in different directions. In some embodiments, the end of the second member 16 may form a protrusion protruding toward first member 18, the protrusion may have a tapered shape and taper to the second extremity 34, and no protrusion protruding toward the second member 16 is formed at the end of the first member 18. Except where otherwise indicated, the second member 16 may have any features of the first member 18 in any given embodiment. Additionally or alternatively, the first member 18 may have any features of the second member 16 in any given embodiment. The first protrusion 30 of the first member 18 has a tapered shape with a gradual reduction in cross-sectional area such that the first protrusion 30 tapers from the third extremity 42 to first extremity 32.

A slot opening 22 is formed between the third extremity 42 and the fourth extremity 40. A slot constriction 24 is formed between the first extremity 32 and the second member 16. A first distance between the third extremity 42 and the fourth extremity 40 is larger by at least 2 times than the second distance between the first extremity 32 and the second member 16. The first distance is also the width of the slot opening 22, the second distance is also the width of the slot constriction 24. In some embodiments, the first distance is larger than the second distance by at least 2.2 times. In some embodiments, the first distance is larger than the second distance by at least 2.6 times. In some embodiments, the first distance is larger than the second distance by at least 3 times. In some embodiments, the first distance is larger than the second distance by at least 4 times. The first distance is at least 1.8 mm in the first embodiment. The second distance is less than 1.0 mm in the first embodiment. In some embodiments, the second distance is less than 0.8 mm. In some embodiments, the second distance is less than 0.7 mm. In some embodiments, the second distance is less than 0.6 mm. The second distance is also the distance from the first extremity 32 to the second extremity 34 in all these embodiments, and the second distance is also the distance from the second extremity 34 to the first member 18 in such embodiments. The third distance between the third extremity and the first extremity is at least 0.8 mm in the first embodiment. The fourth distance between the fourth extremity and the second extremity is at least 0.8 mm in the first embodiment. In some embodiments, the third distance is at least 1.0 mm, and in some embodiments the fourth distance is at least 1.0 mm. In some embodiments, the third distance is at least 1.2 mm, and in some embodiments the fourth distance is at least 1.2 mm.

The slot 28 narrows continuously from the slot opening 22 to the slot constriction 24 in the first embodiment. That is, there are no discontinuities or abrupt changes in the profile of the slot 28 edges from the slot opening 22 to the slot constriction 24. The relatively wider slot opening 22 is very helpful to catch the elastic rubber band (not shown) in the very beginning of a process of inserting the rubber band into the slot 28. The constriction 24 is useful for preventing the elastic rubber band from unintentionally falling off or otherwise unintentionally exiting the slot 28. The elastic rubber band must be pulled in a certain direction to remove the elastic rubber band from the orthodontic hook 10 in this embodiment. The relatively large and smooth guiding surfaces 36 and 38 have no sharp edges so as to minimally irritate the tongue and the buccal mucosa. The orthodontic hook 10 can be made of metal, plastic, ceramic, composite resin, or any other suitable materials for example.

The connection part 14 can act as an attachment for aligner treatment to improve an aligner's control of tooth movement, especially for canine teeth (typically of a human patient). By using the orthodontic hook 10, the aligner (not shown) can cover the connection part 14 of the hook 10 and the connection part 14 may have an attachment formation (not shown). In various embodiments, the aligner (not shown) does not need a cutout to place an orthodontic hook 10. When the hook 10 is cemented on a tooth crown, the cantilevered part 50 and the slot 28 may be directly above the tooth root and the elastic rubber band placed on the orthodontic hook 10 is advantageously close to the resistance center of the tooth, therefore orthodontic hook 10 facilitates the tooth having an improved chance to do bodily movement. The hook 10 can be smooth to minimally irritate the tongue and mucosa. In some embodiments, the end of the first member 18 has a similar shape as the end of the second member 16 shown in FIG. 2. In such embodiments, no protrusion protruding toward the second member 16 is present at the end of the first member 18, such that the slot guiding portion defined by the first guiding surface 36 and the second guiding surface 38 lead to a pair of flattened parallel edges (not shown) extending inwardly at both sides of the slot 28.

In the embodiment shown in FIGS. 1-3, the slot 28 consists of the slot opening 22, the slot guiding portion defined by the first guiding surface 36 and the second guiding surface 38, the slot constriction 24, and the slot center 26 defined by the cantilevered part 50.

FIG. 3 is a side view of the first embodiment of the orthodontic hook 10. FIGS. 1 and 3 show the cantilevered part 50 is not directly above the base pad 12. In some embodiments, part of the cantilevered part 50 is directly above the base pad 12. In some embodiments, the entire cantilevered part 50 is directly above the base pad 12. The top surface 56 of the connection part 14 and the top surface 58 of the cantilevered part 50 is on a same plane (i.e. are coplanar). In this embodiment, the top surface 56 of the connection part 14 and the top surface 58 of the cantilevered part 50 are at the same vertical height above the base pad 12. In other embodiments, the top surface of different parts of the hook body 52 may not be at the same vertical height above the base pad 12.

An elastic band (not shown) engaged with the orthodontic hook 10 in an orthodontic treatment may have a first thickness when stretched and a second (typically larger) thickness when relaxed. The second distance of the slot constriction 24 is preferably less than the second thickness of the elastic band, but greater than the first thickness of the elastic band. The second thickness of elastic bands used in orthodontic treatment is typically larger than 1.0 mm. The second distance D2 is less than 1.0 mm in the first embodiment. The first distance of the slot opening 22 is preferably greater than the second thickness of the elastic band such that the slot opening 22 may catch the elastic band, and the elastic band having the first thickness when stretched by a force F may slide along the guiding surfaces 36 and 38 and pass the slot constriction 24, thereafter entering the slot center 26. The slot constriction 24 may be dimensioned to impede, but not prevent, removal of an elastic band from the slot center 26.

Unless otherwise stated herein, each distance from a point to a surface is the shortest distance from the point to the surface, and each distance between two points is the shortest distance between these two points. Unless otherwise stated herein, height refers to a perpendicular distance from a point at a certain part of the top surface to an ideal plane of the base pad 12.

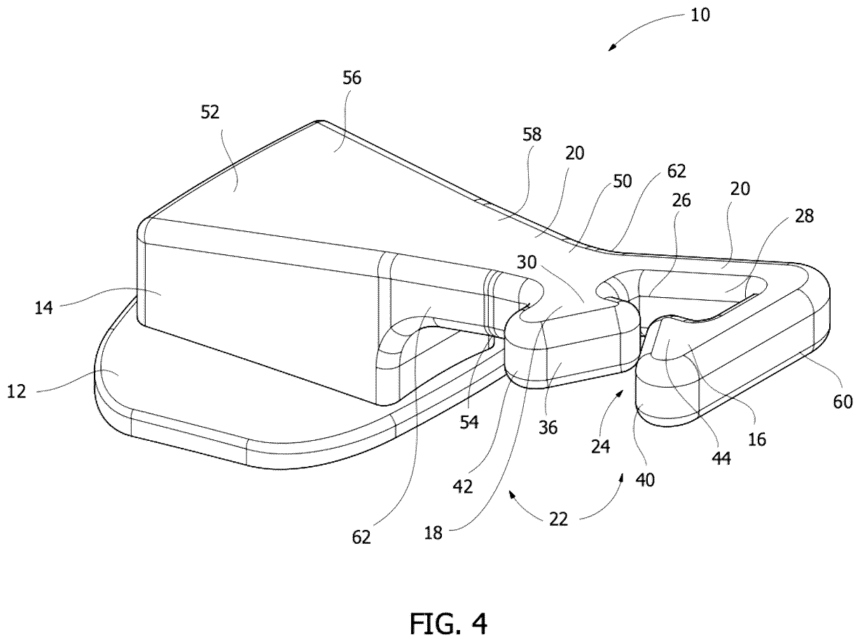

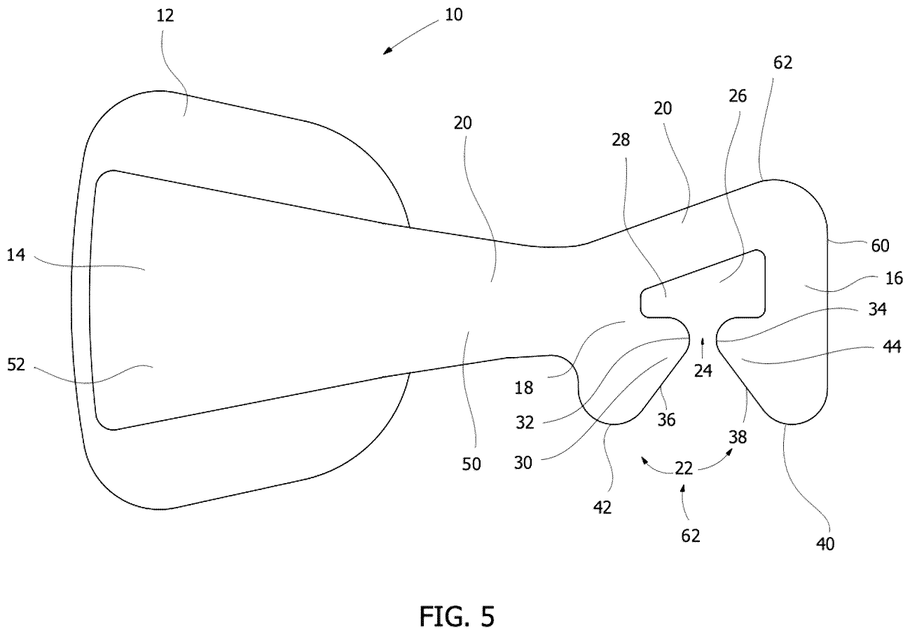

FIG. 4 is a perspective view of a second embodiment of the orthodontic hook, and FIG. 5 is a top view of the second embodiment of the orthodontic hook 10. The second embodiment is similar to the first embodiment. For example, the orthodontic hook 10 is attachable to one of a tooth surface (not shown) and an orthodontic appliance (not shown). The hook 10 includes a base pad 12 that is attachable to a tooth surface. The orthodontic hook 10 includes a hook body 52 that includes a connection part 14 projecting from the base pad 12. A cantilevered part 50 of the hook body 52 extends laterally from the connection part 14. The connection part 14 can be the orthodontic appliance such as a Carriere® Motion Appliance, Buccal Tube, Attachment, or Bracket etc. The cantilevered part 50 comprises a first member 18, a second member 16, and a joint member 20. A slot 28 is formed in the cantilevered part 50, and the first member 18 and the second member 16 are separated from each other by the slot 28. The joint member 20 next to the connection part 14 connects to the first member 18 and the second member 16, and the joint member 20 is placed between the first member 18 and the second member 16. The joint member 20 is disposed at the end of the slot 28.

One of the differences between the first and second embodiments is that the end of the second member 16 in the second embodiment forms a second protrusion 44 protruding toward the first member 18. The second protrusion 44 has a tapered shape and tapers from the fourth extremity 40 to the second extremity 34 of the second member 16, while the first protrusion 30 has a tapered shape and tapers from the third extremity 42 to the first extremity 32 of the first member 18. In this second embodiment, the first protrusion 30 extends toward the second member 16 from the first member 18, and the second protrusion 44 extends toward the first member 18 from the second member 16, such that the slot constriction 24 is formed between the end 32 of the first protrusion 30 and the end 34 of the second protrusion 44. The slot 28 continuously narrows from the slot opening 22 to the slot constriction 24, and continuously widens from the slot constriction 24 to the slot center 26. Between the slot opening 22 and the slot constriction 24, a first guiding surface 36 is at the first protrusion 30 and a second guiding surface 38 is at the second protrusion 44. The second protrusion 44 also has a tapered shape tapering to the end 34 of the second protrusion 44; the end 34 is also the second extremity 34, of the second member 16, which is maximally proximate to the first member 18; and the end 32 is also the first extremity 32 of the first member 18. The slot constriction 24 is formed between the first extremity 32 and the second extremity 34 in the second embodiment. The slot center 26 is surrounded by the first member 18, the second member 16, the joint member 20, the first protrusion 30, and the second protrusion 44. The first member 18 defines a third extremity 42 which is maximally distal from the joint member 20, and the second member 16 defines a fourth extremity 40 which is maximally distal from the joint member 20. In this second embodiment, the slot opening 22 and the slot constriction 24 are located at one of the side edges 62 of the cantilevered part 50. Alternatively, the slot opening 22 may be located at the other side edge 62, or at the terminal edge 60 of the cantilevered part 50 in other embodiments.

In this embodiment the slot 28 consists of the slot opening 22, the slot guiding portion defined by the first guiding surface 36 and the second guiding surface 38, the slot constriction 24, and the slot center 26 defined by the cantilevered part 50.

As best seen in FIG. 5, the connection part 14 has a tapered shape and tapers from one end of the connection part 14 to the cantilevered part 50.

A slot opening 22 is formed between the third extremity 42 and the fourth extremity 40. The slot constriction 24 is formed between the first extremity 32 and the second extremity 34 in the second embodiment. A first distance between the third extremity 42 and the fourth extremity 40 is larger by at least 2.6 times than the second distance between the first extremity 32 and the second extremity 34. In some embodiments, the first distance is larger than the second distance by at least 2.2 times. In some embodiments, the first distance is larger than the second distance by at least 3 times. In some embodiments, the first distance is larger than the second distance by at least 4 times. The first distance is at least 1.8 mm in the second embodiment. The second distance is less than 1.0 mm in the second embodiment. In some embodiments, the second distance is less than 0.8 mm. In some embodiments, the second distance is less than 0.6 mm. In the second embodiment, the second distance is also the distance from the first extremity 32 to the second extremity 34, and the second distance is also the distance from the second extremity 34 to the first member 18. The third distance between the third extremity and the first extremity is at least 0.8 mm in the second embodiment. The fourth distance between the fourth extremity and the second extremity is at least 0.8 mm in the second embodiment. In some embodiments, the third distance is at least 1.0 mm, while in some embodiments the fourth distance is at least 1.0 mm. In some embodiments, the third distance is larger than the second distance, while in some embodiments the fourth distance is larger than the second distance. In some embodiments, the third distance is larger by at least 3 times than the second distance, while in some embodiments the fourth distance is larger by at least 3 times than the second distance. In some embodiments, the third distance is larger by at least 2 times than the second distance, while in some embodiments the fourth distance is larger by at least 2 times than the second distance. In some embodiments, the third distance is larger by at least 1.5 times than the second distance, while in some embodiments the fourth distance is larger by at least 1.5 times than the second distance. The third distance is the length of the first guiding surface 36, the fourth distance is the length of the second guiding surface 38. Big guiding surface is the character of the embodiments in this application, these two big guiding surfaces make the small slot constriction 22 workable and less irritable to surrounding mucosa and gum of a patient.

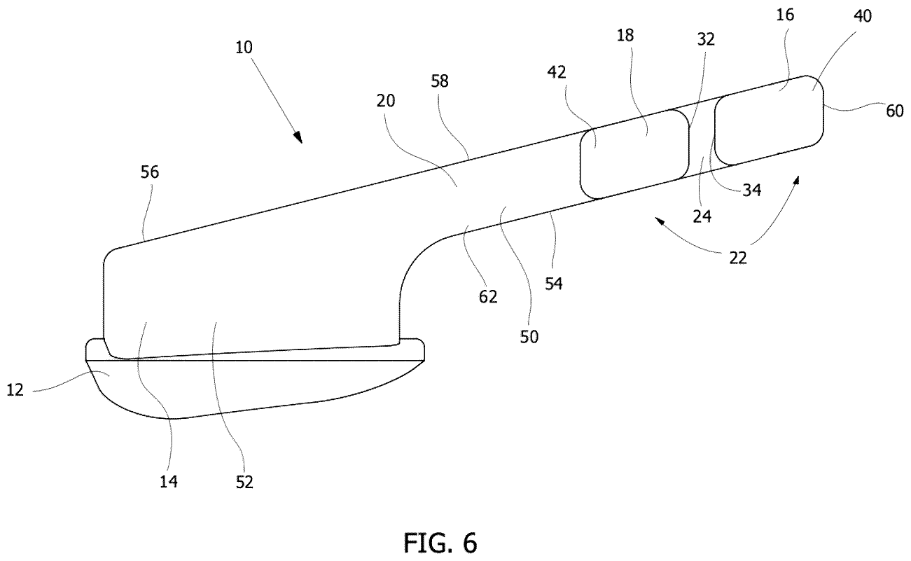

FIG. 6 is a side view of the second embodiment of the orthodontic hook 10. FIGS. 4 and 6 show that the top surface 58 of the cantilevered part 50 is further vertically from the lower plane of the base pad 12 than is the top surface 56 of the connection part 14. In this embodiment, the top surfaces of different parts of the hook body 52 are at different heights above the base pad 12. In a variation, the bottom surface 54 at the first member 18 and the second member 16 may be at different distances from the base pad 12 plane. The distance between the top surface (56 and 58) of the hook 10 and the base pad 12 is gradually increased from the end of the connection part 14 to the distal end of the cantilevered part 50.

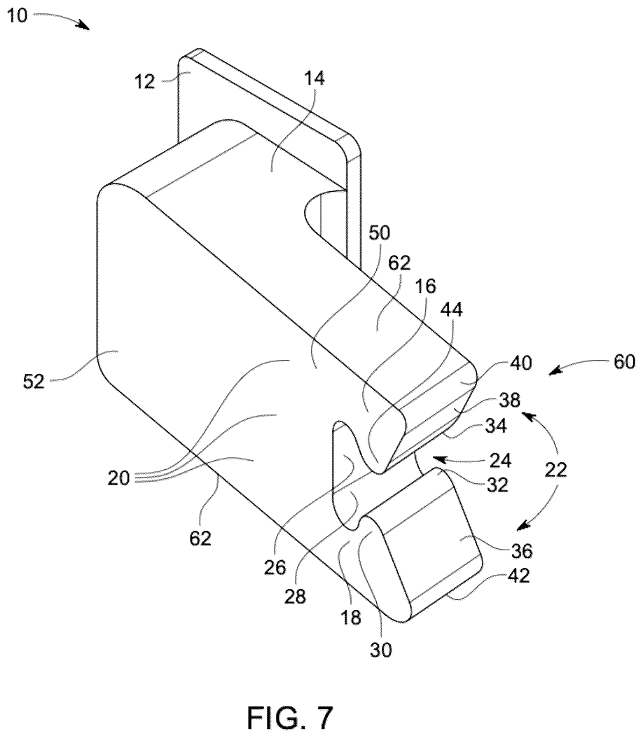

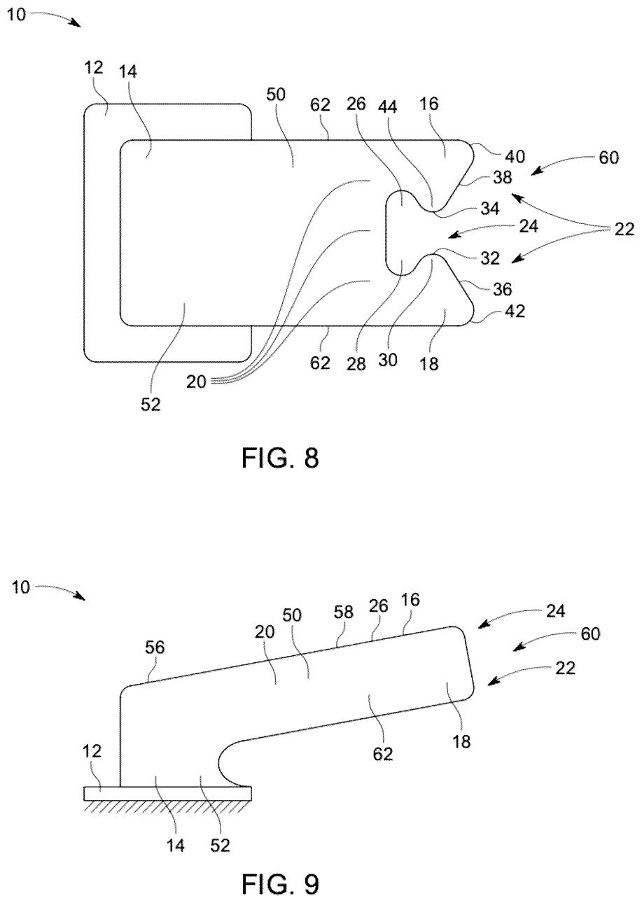

FIG. 7 shows a perspective view of a third embodiment of the orthodontic hook 10. FIG. 8 shows a top view of the third embodiment of the orthodontic hook 10. In this embodiment, the orthodontic hook 10 is attachable to one of a tooth surface (not shown) and an orthodontic appliance (not shown). The hook 10 includes a base pad 12 that is attachable to the tooth surface. The orthodontic hook 10 also includes a hook body 52. The hook body 52 includes a connection part 14 projecting from the base pad 12 and includes a cantilevered part 50. The cantilevered part extends laterally from the connection part 14. The cantilevered part 50 comprises a first member 18, a second member 16, and a joint member 20. A slot 28 is formed in the cantilevered part 50, and the first member 18 and the second member 16 are separated from each other by the slot 28. The joint member 20 next to the connection part 14 is connected to the first member 18 and the second member 16, and the joint member 20 is placed between the first member 18 and the second member 16. The joint member 20 is disposed at the end of the slot 28. The third embodiment is similar to the second embodiment, and one of the differences between these two embodiments is that the slot opening of the third embodiment is located at the terminal edge 60 of the cantilevered part 50. The slot constriction 24 is also located at the terminal edge 60 of the cantilevered part 50 in the third embodiment. This third embodiment provides a different place for receiving the elastic rubber band (not shown). The elastic rubber band in this hook 10 can receive the dragging force from the mesial or distal direction, for example.

The first member 18 defines a third extremity 42 which is maximally distal from the joint member 20 and defines a first extremity 32 which is maximally proximate to the second member 16, and the second member 16 defines a fourth extremity 40 which is maximally distal from the joint member 20 and defines a second extremity 34 which is maximally proximate to the first member 18. A slot constriction 24 is formed between the first extremity 32 and the second extremity 34. The slot opening 22 extends between the third extremity 42 and the fourth extremity 40. The slot center 26 is surrounded by the first member 18, the second member 16, the joint member 20, the first protrusion 30, and the second protrusion 44. The slot 28 narrows from the slot opening 22 to the slot constriction 24 and widens from the slot constriction 24 to the slot center 26. A first guiding surface 36 is formed between the third extremity 42 and the first extremity 32, and a second guiding surface 38 is formed between the fourth extremity 40 and the second extremity 34. The end of the first member 18 forms the first protrusion 30 which has a tapered shape with a gradual reduction in cross-sectional area and which tapers from the third extremity 42 to first extremity 32. The end of the second member 16 forms the second protrusion 44 which has a tapered shape with a gradual reduction in cross-sectional area such that the second protrusion 44 tapers from the fourth extremity 40 to second extremity 34.

A slot opening 22 is formed between the third extremity 42 and the fourth extremity 40. A slot constriction 24 is formed between the first extremity 32 and the second extremity 34 of the second member 16. A first distance of the slot opening 22 between the third extremity 42 and the fourth extremity 40 is larger by at least 2.2 times than the second distance of the slot constriction 24 between the first extremity 32 and the second extremity 34. In some embodiments, the first distance is larger than the second distance by at least 4 times. In some embodiments, the first distance is larger than the second distance by at least 2.6 times. In some embodiments, the first distance is larger than the second distance by at least 3 times. The first distance is at least 1.8 mm in the third embodiment. The second distance is less than 0.5 mm in the third embodiment. In some embodiments, the second distance is less than 0.8 mm. In some embodiments, the second distance is less than 0.6 mm. In the third embodiment, the second distance is also the distance from the first extremity 32 to the second member 16, and the second distance is also the distance from the second extremity 34 to the first member 18. The third distance between the third extremity and the first extremity is at least 1.2 mm in the third embodiment. The fourth distance between the fourth extremity and the second extremity is at least 1.2 mm in the third embodiment. In some embodiments, the third distance is larger by at least 2 times than the second distance, while in some embodiments the fourth distance is larger by at least 2 times than the second distance. In this embodiment, the third distance is larger than the second distance, and the fourth distance is larger than the second distance. In some embodiments, the third distance is larger by at least 3 times than the second distance, while in some embodiments the fourth distance is larger by at least 3 times than the second distance.

In this embodiment, the first member 18 and the second member 16 may be at different heights from the base pad 12 plane. In use, an arch wire (not shown) may pass through the slot center 26. One or more hooks 10 may be cemented on different teeth in the same dental arch, and the arch wire may pass through the slot centers of the hooks to align these different teeth. The width of the slot center 26 between the joint member 20 and the first member 18 may be about 0.018 inch, and the width of the slot center 26 between the joint member 20 and the second member 16 may be about 0.018 inch. A ligation wire (not shown) may enter the slot center 26 to fix the arch wire. Additionally or alternatively, composite resin may be used to fix the arch wire.

FIG. 9 is a side view of the third embodiment of the orthodontic hook 10, which shows that the top surface 56 of the connection part 14 and the top surface 58 of the cantilevered part 50 are not at the same height above the lower plane of the base pad 12. The top surface 58 of the cantilevered part 50 is further away from the base pad 12 plane than the top surface 56 of the connection part 14, such that the perpendicular distance from a point at the top surface 58 to the base pad12 plane is larger than the perpendicular distance from a point at the top surface 56 to the base pad 12 plane. Only part of the cantilevered part 50 is directly above the base pad 12. In this embodiment, the first member 18 and the second member 16 may be at different heights from the plane of the base pad 12.

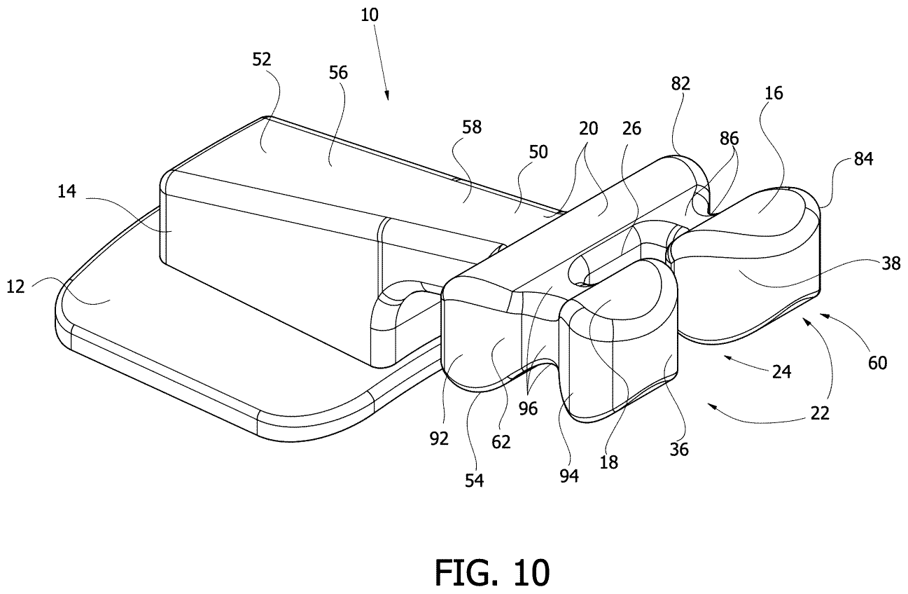

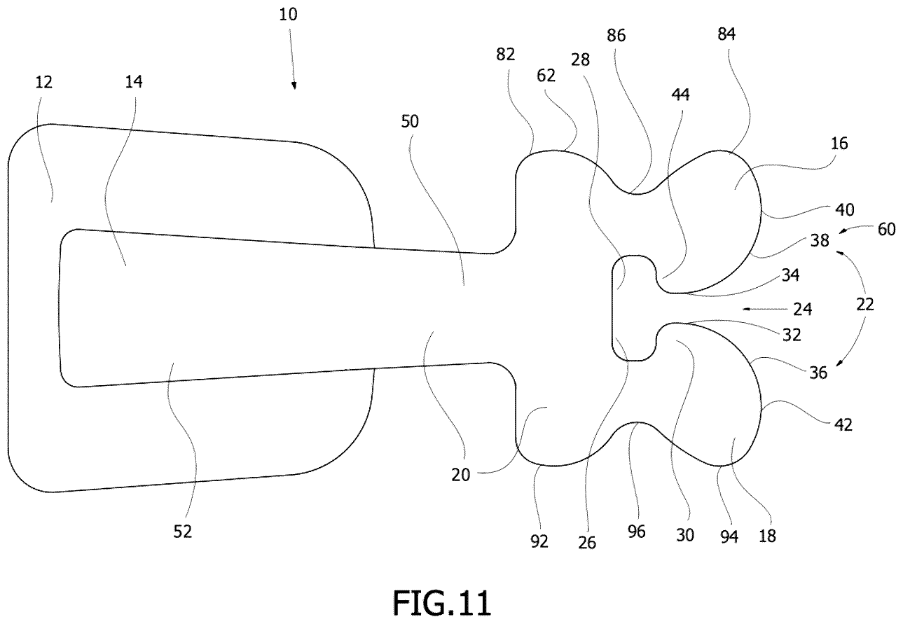

FIG. 10 is a perspective view of a fourth embodiment of the orthodontic hook 10. FIG. 11 is a top view of the fourth embodiment of the orthodontic hook 10. In this embodiment the hook 10 includes a base pad 12 that is attachable to the tooth surface. While a variety of attachment techniques may be employed, usually the base pad is cemented onto the tooth surface. The orthodontic hook 10 also includes a hook body 52. The hook body 52 includes a connection part 14 projecting from the base pad 12 and includes a cantilevered part 50. The cantilevered part extends laterally from the connection part 14. The cantilevered part 50 comprises a first member 18, a second member 16, and a joint member 20. A slot 28 is formed in the cantilevered part 50, and the first member 18 and the second member 16 are separated from each other by the slot 28. The joint member 20 next to the connection part 14 is connected to the first member 18 and the second member 16, and the joint member 20 is placed between the first member 18 and the second member 16. The joint member 20 is disposed at the end of the slot 28.

The first member 18 defines a third extremity 42 which is maximally distal from the joint member 20 and defines a first extremity 32 which is maximally proximate to the second member 16, and the second member 16 defines a fourth extremity 40 which is maximally distal from the joint member 20 and defines a second extremity 34 which is maximally proximate to the first member 18. A slot constriction 24 at the terminal edge 60 is formed between the first extremity 32 and the second extremity 34. The slot 28 has a slot opening 22 at the terminal edge 60 of the cantilevered part 50. The slot opening 22 extends between the third extremity 42 and the fourth extremity 40. The slot center 26 is surrounded by the first member 18, the second member 16, the joint member 20, the first protrusion 30, and the second protrusion 44. The slot 28 narrows from the slot opening 22 to the slot constriction 24 and widens from the slot constriction 24 to the slot center 26. A first guiding surface 36 is formed between the third extremity 42 and the first extremity 32, and a second guiding surface 38 is formed between the fourth extremity 40 and the second extremity 34. The end of the first member 18 forms the first protrusion 30 which has a tapered shape with a gradual reduction in cross-sectional area and which tapers from the third extremity 42 to first extremity 32. The end of the second member 16 forms the second protrusion 44 which has a tapered shape with a gradual reduction in cross-sectional area such that the second protrusion 44 tapers from the fourth extremity 40 to second extremity 34.

This fourth embodiment is similar to the third embodiment, and one of the differences between these two embodiments is that a first indentation 96 is arranged at the first member 18 and a second indentation 86 is arranged at the second member 16 in the fourth embodiment. The first indentation 96 is placed between the joint member 20 and the end part of the first member 18. The first indentation 96 is disposed at the first member 18 along the first side edge 62, the top surface 58 and the bottom surface 54 of the cantilevered part 50. The second indentation 86 is placed between the joint member 20 and the end part of the second member 16. The second indentation 86 is disposed at the second member 16 along the second side edge 62, the top surface 58 and the bottom surface 54 of the cantilevered part 50. The end part of the first member 18 has a second side protrusion 94 that extends in a direction away from the second member 16. The joint member 20 has a first side protrusion 92 that extends parallel to the second side protrusion 94. The first side protrusion 92 and the second side protrusion 94 are arranged to hold an elastic rubber band in the first indentation 96 of the first member 18. The end part of the second member 16 has a fourth side protrusion 84 that extends in a direction away from the first member 18. The joint member 20 has a third side protrusion 82 that extends parallel to the fourth side protrusion 84. The third side protrusion 82 and the fourth side protrusion 84 are arranged to hold the elastic rubber band in the second indentation 86 of the second member 16. The first indentation 96, the second indentation 86 and the slot center 26 may also be used to hold an arch wire (not shown) to correct a tooth position in some situations. Composite or ligation wire (not shown) may be used to fix the arch wire in the slot center 26. An arch wire may pass through at least two different slot centers 26 of two different orthodontic hooks 10 cemented on different teeth in the same dental arch if their respective slots centers 26 extend mesiodistally, for example.

Different portions of the joint member 20 may have different widths in the fourth embodiment. As shown in FIGS. 10 and 11, the width of the portion of the joint member 20 next to the connection part 14 is narrower than the width of the portion of the joint member 20 next to the slot center 26.

As best seen in FIG. 11, the connection part 14 has a tapered shape and tapers from one end of the connection part 14 to the cantilevered part 50. The connection part 14 may be a bracket for an arch wire (not shown) in some cases. The connection part 14 may be another orthodontic appliance in other cases.

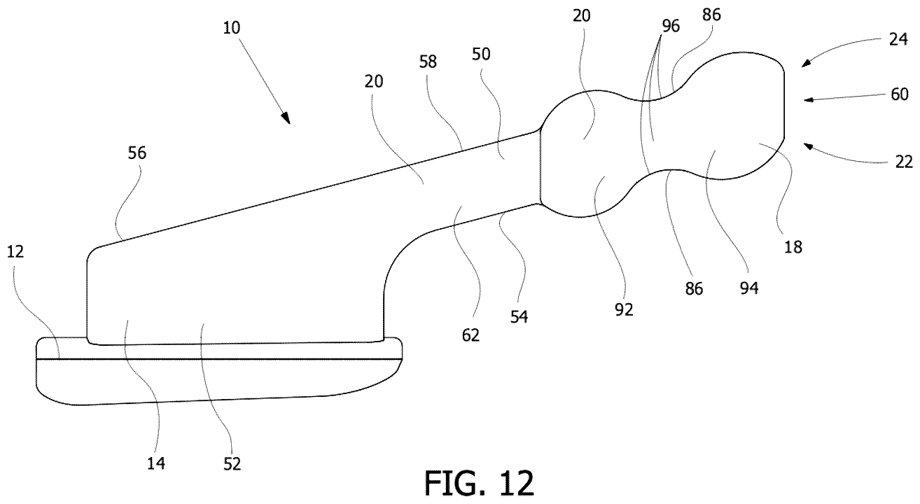

FIG. 12 is a side view of the fourth embodiment of the orthodontic hook 10. FIG. 12 shows the first indentation 96 arranged at the first side edge 62 of the cantilevered part 50 at the first member 18. While not directly visible in FIG. 12, the second indentation 86 is arranged at the second side edge 62 of the cantilevered part 50 at the second member 16. The top surface 56 of the connection part 14 and the top surface 58 of the cantilevered part 50 are not at the same distance from the base pad 12 plane. In a variation, the bottom surface 54 at the first member 18 and the second member 16 may be at different distances from the base pad 12 plane. The distance between the top surface of the hook 10 and the base pad 12 is gradually increased from the end of the connection part 14 to the distal end of the cantilevered part 50.

Referring back to FIGS. 10 and 11, a slot opening 22 is formed between the third extremity 42 and the fourth extremity 40. A slot constriction 24 is formed between the first extremity 32 of the first member 18 and the second extremity 34 of the second member 16. The first distance of the slot opening 22 between the third extremity 42 and the fourth extremity 40 is larger by at least 3 times than the second distance of the slot constriction 24 between the first extremity 32 and the second extremity 34. In some embodiments, the first distance is larger than the second distance by at least 2.6 times. In some embodiments, the first distance is larger than the second distance by at least 4 times. In the fourth embodiment, the first distance is at least 2.4 mm. In the fourth embodiment, the second distance is less than 0.5 mm. In some embodiments, the second distance is less than 0.8 mm. In some embodiments, the second distance is less than 0.6 mm. In the fourth embodiment, the second distance is also the distance from the first extremity 32 to the second member 16, and the second distance is also the distance from the second extremity 34 to the first member 18. The third distance between the third extremity 42 and the first extremity 32 is at least 2.2 mm in the fourth embodiment. The fourth distance between the fourth extremity 40 and the second extremity 34 is at least 2.2 mm in the fourth embodiment. In some embodiments, the third distance is at least 1.8 mm, and in some embodiments the fourth distance is at least 1.8 mm. In some embodiments, the third distance is larger by at least 2 times than the second distance. In some embodiments, the fourth distance is larger by at least 2 times than the second distance. In the fourth embodiment, the third distance is at least 3 times larger than the second distance, and the fourth distance is at ieast 3 times larger than the second distance. In some embodiments, the third distance is larger by at least 1.5 times than the second distance. In some embodiments, the fourth distance is larger by at least 1.5 times than the second distance.

In variations of all the embodiments, each of the first extremity, second extremity, third extremity and fourth extremity may form a single point, line, or area, for example.

Various features have been described and illustrated in association with specific embodiments of the invention. Except where an incompatible combination of features would result, any feature described or illustrated in association with a particular embodiment herein may be employed with any other embodiment described or illustrated herein.

### Reference Characters Associated With the Drawings

Orthodontic hook 10
Base pad 12
Connection part of hook body 14
Second member of Cantilevered Part 16
First member of Cantilevered Part 18
Joint member of Cantilevered Part 20
Slot Opening 22
Slot Constriction 24
Slot Center 26
Slot 28
First Protrusion 30
First extremity 32
Second extremity 34
First guiding surface 36
Second guiding surface 38
Fourth extremity 40
Third extremity 42
Second protrusion 44
Cantilevered part 50
Hook Body 52
Bottom surface of the cantilevered part 54
Top surface of the connection part 56
Top surface of the cantilevered part 58
Terminal edge of the cantilevered part 60
Side edge of the cantilevered part 62
Second indentation 86
Third side protrusion 82
Fourth side protrusion 84
First indentation 96
First side protrusion 92
Second side protrusion 94

While embodiments of the invention have been described and illustrated, such embodiments should be considered illustrative of the invention only. The invention may include variants not described or illustrated herein in detail. Thus, the embodiments described and illustrated herein should not be considered to limit the invention as construed in accordance with the accompanying claims.

What is claimed is:

1. An orthodontic hook attachable to one of a tooth surface and an orthodontic appliance, the hook comprising:
(a) a base pad attachable to said one of the tooth surface and the orthodontic appliance; and
(b) a hook body comprising a connection part projecting from the base pad, and a cantilevered part extending laterally from the connection part, the cantilevered part comprising a first member and a second member separated from the first member by a slot formed in the cantilevered part, the cantilevered part further comprising a joint member disposed next to the connection part, the joint member being disposed at an end of the slot for connecting between the first member and the second member, a first end of the first member forming a first protrusion protruding toward the second member, a second end of the second member forming a second protrusion protruding toward the first member, the first member defining a first extremity which is maximally proximate to the second member, the second member defining a second extremity which is maximally proximate to the first member, a slot constriction being defined between the first extremity and the second extremity, wherein the slot constriction is positioned at a terminal edge of the cantilevered part.

2. The orthodontic hook of claim 1 wherein the first member defines a third extremity which is maximally distal from the joint member, the second member defines a fourth extremity which is maximally distal from the joint member, a slot opening is defined between the third extremity and the fourth extremity, and the slot continuously narrows from the slot opening to the slot constriction.

3. The orthodontic hook of claim 2 wherein a first distance between the third extremity and the fourth extremity is larger by at least 3 times than a second distance between the first extremity and the second extremity.

4. The orthodontic hook of claim 2 wherein a third distance between the third extremity and the first extremity is larger by at least 2 times than a second distance between the first extremity and the second extremity.

5. The orthodontic hook of claim 4 wherein a fourth distance between the fourth extremity and the second extremity is larger by at least 2 times than the second distance.

6. The orthodontic hook of claim 1 wherein a first indentation of the cantilevered part is formed at the first member between the joint member and the first end of the first member, and a second indentation of the cantilevered part is formed at the second member between the joint member and the second end of the second member.

7. The orthodontic hook of claim 6 wherein the first indentation is placed at a first side edge of the cantilevered part at the first member, and the second indentation is placed at a second side edge of the cantilevered part at the second member.

8. The orthodontic hook of claim 6 wherein the first indentation is arranged at a top surface and a bottom surface of the cantilevered part at the first member, and the second indentation is arranged at a top surface and a bottom surface of the cantilevered part at the second member.

9. The orthodontic hook of claim 2 wherein the slot continuously widens from the slot constriction to a slot center, and wherein the first protrusion has a tapered shape and tapers from the third extremity to the first extremity.

10. The orthodontic hook of claim 9 wherein the second protrusion has a tapered shape and tapers from the fourth extremity to the second extremity.

11. An orthodontic hook attachable to one of a tooth surface and an orthodontic appliance, the hook comprising:
(a) a base pad attachable to said one of the tooth surface and the orthodontic appliance; and
(b) a hook body comprising a connection part projecting from the base pad, and a cantilevered part extending laterally from the connection part, the cantilevered part comprising a first member and a second member separated from the first member by a slot formed in the cantilevered part, the cantilevered part further comprising a joint member disposed next to the connection part, the joint member being disposed at an end of the slot for connecting between the first member and the second member, the first member defining a first extremity which is maximally proximate to the second member, the first member further defining a third extremity which is maximally distal from the joint member, the second member defining a second extremity which is maximally proximate to the first member, the second member further defining a fourth extremity which is maximally distal from the joint member, a slot opening being defined between the third extremity and the fourth extremity, a slot constriction being defined between the first extremity and the second extremity, the slot continuously narrowing from the slot opening to the slot constriction, wherein a first distance between the third extremity and the fourth extremity is larger by at least 3 times than a second distance between the first extremity and the second extremity.

12. The orthodontic hook of claim 11 wherein the slot continuously widens from the slot constriction to a slot center, and wherein a first end of the first member forms a first protrusion protruding toward the second member, and wherein the first protrusion has a tapered shape and tapers from the third extremity to the first extremity.

13. The orthodontic hook of claim 12 wherein a second end of the second member forms a second protrusion protruding toward the first member, and wherein the second protrusion has a tapered shape and tapers from the fourth extremity to the second extremity.

14. The orthodontic hook of claim 11 wherein a third distance between the third extremity and the first extremity is larger by 2 times than the second distance.

15. The orthodontic hook of claim 14 wherein a fourth distance between the fourth extremity and the second extremity is larger by 2 times than the second distance.

16. The orthodontic hook of claim 11 wherein the slot opening is positioned at a terminal edge of the cantilevered part.

17. The orthodontic hook of claim 16 wherein a first indentation of the first member is formed between the joint member and the first end of the first member, and a second indentation of the second member is formed between the joint member and the second end of the second member.

18. The orthodontic hook of claim 17 wherein the first indentation is placed at a first side edge of the cantilevered part at the first member, and the second indentation is placed at a second side edge of the cantilevered part at the second member.

19. The orthodontic hook of claim 17 wherein the first indentation is arranged at a top surface and a bottom surface of the cantilevered part at the first member, and the second indentation is arranged at a top surface and a bottom surface of the cantilevered part at the second member.
